(19) United States
(12) Patent Application Publication
(10) Pub. No.: US 2007/0243236 A1
(43) Pub. Date: Oct. 18, 2007

(54) High nutrient concentration feed

(76) Inventors: Carlos Ibanez Cerda, Elk River, MN (US); David Alan Cook, Coons Rapids, MN (US); Scott Lynn Tilton, Princeton, MN (US); Gregory Lowell Engelke, New Brighton, MN (US); Neal Jakel, Lake Zurich, IL (US); Paul McWilliams, Racine, WI (US); Francis Andriaens, Westfield, NJ (US); Bob Barclay, Norwalk, CT (US); Mike Stern, Glencoe, IL (US); Dan Dyer, (US); Dave Russell, Libertyville, IL (US); Fang Chi, Libertyville, IL (US); Troy Lohrmann, Lake Villa, IL (US)

Correspondence Address: BANNER & WITCOFF, LTD., 1100 13th STREET, N.W., SUITE 1200, WASHINGTON, DC, 20005-4051, US

(21) Appl. No.: 11/405,670

(22) Filed: Apr. 18, 2006

(51) Int. Cl. A23K 1/165; A23K 1/17

(52) U.S. Cl. 424/442; 426/635

(57) ABSTRACT

An animal diet and method of feeding an animal an amount of different pelleted feed compositions having different amounts of available energy per kilogram of the composition and a different specific ratio of kilocalories total available energy per gram amino acids throughout the animal lifecycles along with the different pelleted feed compositions and the methods of making those compositions that yield improved efficiencies in overall animal production methods.

### FIELD OF THE INVENTION

The present invention relates to animal feed formulations. More particularly, aspects of the invention are directed toward compositions of high nutrient animal feed compositions and methods of manufacturing and utilizing the same.

### DESCRIPTION OF THE RELATED ART

Animal feed mixtures are generally formulated based upon a combination of the nutrient needs of the animal and those ingredients readily available to the manufacturer. Therefore, diets are typically formulated based on the use of local commodities. In North America, diets are formulated utilizing corn, soybean meal, along with vitamins and minerals, animal and/or vegetable fat, and potentially limited amounts of other co-product ingredients. Examples of co-products may include, for example, wheat midds, bakery by-product meal, poultry by-product meal, meat and bone meal, and distillers dried grains. Yet in other areas of the world ingredients such as wheat, barley, tapioca, canola, and other plant based ingredients may be utilized in combination with or in replacement of these and other ingredients.

Due to the multi-faceted aspects of proper nutrient requirements and manufacturing constraints, many animals, such as, for example, poultry, and swine species are consuming diets that are not capable of maximizing their production potential including but not limited to: weight gain, feed efficiency, lean tissue accretion, carcass yield, meat quality, egg mass per hen, among others. That is, the feed that may be manufactured does not meet the animal requirements for maximal cost-effective production potential and the feed may not be modified to meet requirements due to manufacturing constraints. This could be due to a variety of factors, such as the inability of the diet to meet either the amino acid, or the energy needs of the animal. Additionally, the current diets of many animal species do not maximize the amount of feed used by the animal to grow and maintain body mass in comparison to the amount of feed consumed by the animal. This leads to increased animal waste and increased manufacturing costs for actual feed used by the animal.

Diets are commonly provided as pelleted feed compositions. One of the limitations found in pelleted feed composition using conventional commodities is that the available energy density of the pellet is highly dependent on the amount of fat or oil in the pellet. However, increased fat or oil content also increases manufacturing difficulties for acceptable pellets. Commonly this places a limitation on crude fat content of the diet being less than 10 to 11%, or added fat being less than 7-8% of the diet, with pelleting processes traditionally used in the livestock industry.

Feed intake may increase in animals that do not receive the required nutrients in the feed for maximal production potential in an attempt to compensate for the difference. Unfortunately, however, in many instances, the animal is unable to consume enough feed to counteract the limitations of the diet. In such cases, the producer may be reducing revenue from the sale of his animals or their products. For example, this may result in either selling lighter weight animals at a constant age, and/or increasing the number of days required to reach target market weights. This causes a plurality of disadvantages. First, there is a reduction in the total pounds of meat sold due to a reduction in the number of pounds produced per livestock yard or barn. Secondly, there is a reduction in the number of animals sold per year. Moreover, when animals are sold at a common age, several additional losses of revenue are possible. First, lighter animals will have reduced carcass yields. Second, these animals will likely have a smaller percentage of the flock/herd eligible for premiums based upon carcass characteristics, and target product weights.

Additionally, animal health and waste management issues are rapidly becoming the primary concerns of many livestock producers in developed areas of the world. Recently imposed regulations regarding waste management and emissions are starting to place limits on total emissions in addition to nitrogen and phosphorus waste regulations. With the advent of such regulations, total gaseous and solid emissions are rapidly joining nitrogen and phosphorus waste potential as key drivers in the formulation of diets for large livestock operations.

What is needed, therefore, is a feed composition that is economical to produce and supply to the animal, yet provides the required energy and amino acids to maximize the animal's growth. Moreover, such a composition would need to be formulated that, when digested by the animal, produces a lower quantity of solid and gaseous wastes.

### SUMMARY OF THE INVENTION

Aspects of the present invention overcome problems and limitations of the prior art by providing specialty ingredients having a higher nutrient concentration than their corresponding commodity type ingredients from which they are derived. In one embodiment, a feed composition may provide significant cost savings when formulated into various animal diets. In addition, the higher nutrient concentration of these ingredients permit the formulation and acceptable manufacturing of pelleted animal feed that may be used in diets containing sufficient nutrient levels that allows the animal to obtain their production potential.

One aspect of the invention relates to utilizing minimally processed agricultural materials to form pelleted animal feed compositions. Minimally processed agricultural materials are byproducts of agricultural materials after processing to modify or remove at least one key component. Some examples of minimally processed agricultural materials include, but are not limited to, soybean meal, canola meal, Golden MaX™ (available from Cargill). In one embodiment, minimally processed soy-derived products are combined with minimally processed corn-derived products to produce an animal feed having a high pellet durability index with total available energy content that preferably ranges from about 3150 to about 3600 kilocalories per kilogram feed composition and a specific ratio of total available energy to total amino acids that preferably varies in range from about 13.5 to about 18.0 kilocalories per gram. Yet still further aspects of the invention relate to the manufacturing of the above animal feed compositions.

In one such embodiment, digestion of the feed by the animal results in a decreased environmental impact when compared to traditional diets. In yet other embodiments, minimally processed products derived from soybeans, canola, corn and other agricultural materials. Another aspect of the present invention relates to supplying a diet to an animal for a first period wherein the diet includes a feed composition having at least one amino acid, a specific amount of total available energy, a specified ratio of total available energy to total amino acid as measured in kilocalories per gram, and a specified ratio of total available energy to a specific amino acid, also measured in kilocalories per gram. A second diet is supplied to an animal for a second period wherein the diet includes a decreased amount of feed composition per kilogram of animal from the feed composition used in the first period. The second feed composition also has at least one amino acid and a different amount of total available energy, ratio of total available energy to total amino acids, and ratio of total available energy to a specific amino acid than the feed composition used in the first period. The specific amino acid being targeted in the feed composition may vary depending on the animal species or animal product being produced. For example, in one embodiment for broilers, the targeted amino acid comprises lysine. Additional diets of varying amounts of additional feed compositions may be fed to the animal between the first and second periods or after the second period.

Of course, the methods and systems of the above-referenced aspects and/or embodiments may also include other additional elements, steps, or ingredients. In this regard, other aspects and/or embodiments are disclosed and claimed herein as well. The details of these and other embodiments of the present invention are set forth in the accompanying description and examples below. Other features and advantages of the invention will be apparent from the description and examples, as well as from the claims.

### DETAILED DESCRIPTION OF THE INVENTION

Current biotechnology techniques allow for the creation of specialty feed ingredients including but not limited to corn, soybeans, canola, and the meals obtained by processing these ingredients for use by the livestock industry. These ingredients may have a higher nutrient concentration than their corresponding commodity type ingredients from which they were derived. As such they provide significant feed cost savings when formulated into high nutrient concentration animal diets with conventional materials. Their value may also increase as diet nutrient concentration increases. For example in a typical diet, an untargeted nutrient dense corn meal may be valued at about 110% of commodity corn. However, when specific amino acids and the energy density are increased to specific levels, its value may increase to about 130% of commodity corn. Additionally, the use of these specialty ingredients may allow for the formulation of diets that more optimally meet maximum target animal production potentials, including, but not limited to less waste per kilogram animal, increased total body mass, decreased total feeding cycle times to meet desired weight ranges and the resulting improved economic and environmental effects achieved from the changed animal production potentials.

Modifications of the commodity ingredients may include increasing one or more of the following: protein content, content of specific amino acid(s), energy content, digestibility, and reducing the anti-nutritional compound contents. Of course, one skilled in the art will readily understand that other modifications of these commodity ingredients may be undertaken. By increasing the concentration of beneficial nutrients, or reducing the content of non-beneficial nutrients, it becomes possible to formulate diets that provide greater levels of protein and energy than currently available in the industry. As the concentration of beneficial nutrients in these ingredients increases, it becomes possible to manufacture and pellet diets that contain much higher levels of energy and amino acids than are currently be obtained using conventional ingredients in conventional pelleting processes

Increasing the energy content of diets has long been known to improve feed efficiency. However, without optimizing amino acid and vitamin and mineral content of these feeds, the diets fed to the animal will not allow for the least feed used per unit of gain. By formulating a well balanced diet correctly formulated in energy and amino acid content with appropriate levels of vitamins and minerals, the animal is able to more efficiently utilize the resources fed to maximize productive yield. Use of the increased nutrient density diets embodied in this document allows for the improvement of feed efficiency beyond values typically observed in the industry.

Unlike these previous attempts to increase the available energy, aspects of the present invention allow for pellets having increased energy to be manufactured with conventional pelleting procedures. Pelleting is the process by which a feed mash may be compressed into a larger particle. The quality of the pellets is affected by the following factors: mean particle size of pellet components; die retention time, and temperature. The description below illustrates one exemplary method that feed compositions according to at least one aspect of the invention may be pelleted.

The first step of pelleting is flowing the feed mash into a conditioner, where steam is added. Generally, the feed mash comprises a mixture of soybean meal and ground corn or corn meal. Preferably the soybean meal is a high protein soybean meal. More preferably, the soybean mash is a high protein soybean meal with a dry weight basis protein amount of about 58%. Even more preferably the soybean meal is a high value soybean meal (HVS) available from Renessen LLC of Deerfield, Illinois. The corn meal may be made from traditional corn meal, corn grits, corn flour, other fractions from processes of making traditional corn meal, or combinations thereof and generally has a dry weight basis starch content from about 60% to about 90% and a dry weight basis protein content from about 5% to about 15%. Preferably, the dry weight basis of the starch content of the corn meal is from about 65% to about 85% and the dry weight basis of the protein content is from about 7.5% to about 15%. More preferably the corn meal is from high value corn from Renessen LLC of Deerfield, Ill. Even more preferably the corn meal is obtained from transgenic corn which contains high concentrations of amino acids, particularly lysine. The transgenic corn preferably is marker free.

A preferred transgenic corn (LY038) can be grown from seeds deposited at the American Type Culture Collection (ATCC®), 10801 University Boulevard, Manassas, Va. 20110 under Accession No. PTA-5623. Alternatively, LY038 corn (or corn with similar lysine concentrations) can be produced as follows. DNA comprising the nucleotide sequence shown in SEQ ID NO:1 and also comprising a promoter such as ³⁵S (Kay et al., Science 236, 1299-302, 1989; U.S. Pat. No. 5,164,316), a selectable marker such as neomycin phosphotransferase II (NPTII), a nopaline synthase (NOS) 3′ untranslated region (Fraley et al., Proc. Natl. Acad. Sci. USA 80, 4803-07, 1983), and a lox P site (U.S. Pat. No. 5,658,772) can be introduced into immature maize embryos using methods well known to those skilled in the art. These methods include, but are not limited to, microprojectile bombardment of immature maize embryos with gold particles to which the DNA is adhered. The nucleotide sequence shown in SEQ ID NO:1 comprises, from 5′ to 3′, a maize globulin 1 promoter (bp 48-1440), a rice actin 1 intron (bp 1448-1928), DNA encoding a maize dihydrodipicolinate synthase (DHDPS) chloroplast transit peptide (bp 1930-2100), DNA encoding a Corynebacterium DHDPS (bp 2101-3003), a 3′ untranslated region from maize globulin 1 (bp 3080-4079), and a lox P site (bp 2091-4124).

Transformed cells are selected using kanamycin selection. Standard methods are then used to produce fertile R₀ transgenic plants from the transformed cells. R₀ plants are crossed with non-transgenic plants to produce F_{1A} seed. NPTII⁺ plants grown from F_{1A} seed are identified using kanamycin selection and crossed with transgenic maize plants which express a bacterial Cre recombinase to produce F_{1B} seeds. Kernels from ears in which free lysine in a kernel sample is about 1000 ppm or over are grown into F_{1B} progeny plants. F_{1B} progeny plants which comprise the Cre recombinase and DHDPS sequences but not the NPTII sequence are identified using Southern blotting and/or PCR. Such plants (“marker excised plants) are self-pollinated to produce F_{2A} seed. F_{2A} seed are planted. Plants comprising the DHDPS sequence but not the Cre recombinase or DHDPS sequences are identified and self-pollinated to form F₃ seeds (LY038). Free lysine content of maize kernels at each stage of the production can be determined by methods known in the art, such as high performance liquid chromatography (HPLC) and liquid chromatography-mass spectrophotometry/mass spectrophotometry (LC-MS/MS).

During the first stage of pelleting, the mean particle size of the feed mash may range from about 400 to about 1200 microns; however, increased deviations are possible. The steam supplied to the feed mash is generally about 20 to about 30 pounds per square inch (psi). Depending on the manufacturer and type of feed being produced the retention time may vary. In one embodiment, the retention time is approximately 15 seconds, however a range of about 10 to about 20 seconds are commonly used. Generally, increased retention time has been associated with improved pellet quality. Indeed, in at least one embodiment, a retention time of 90 seconds may be utilized. In addition to retention time, the temperature of the mash while in the conditioner is important to the final pellet quality. Temperatures of the mash in the conditioner may range from about 176° F. to about 194° F. One skilled in the art, however, will understand that the temperatures utilized may be higher or reduced, depending on a myriad of factors, including but not limited to the type and quantity of feed, the retention time, and other manufacturing preferences.

Once the steam has been in contact with the mash for a predetermined amount of time, the conditioned mash then flows into the pelleting chamber. The pelleting chamber may cause compression of the pellet by one or more die. In one embodiment, feed compositions are compressed by die having diameters of about 1/8 inches to about 3/16 inches. The amount of compression applied to the mash may vary depending on the factors described above, among others known in the art. In one embodiment, the feed compositions are compressed at about a 1:12 to about a 1:13 ratio. Indeed, in one embodiment, the friction that occurs as the mash passes through the die may increase the temperature of the mash by approximately 10° F.

After going through the die, the pellets may pass through a cooling mechanism. The cooling mechanism may be vertical, horizontal, or counterflow. Upon cooling, pellets may be resized and/or crumbled. One of ordinary skill in the art will readily understand that various omissions, additions, and modifications may be made to the illustrative commercial pelleting process.

Prior art attempts to increase overall energy of pelleted animal feed compositions included the application of animal fat. This procedure, however, resulted in decreased pellet durability as measured by the Pellet Durability Index (PDI) and an increase of pellet fines when undergoing the pelleting process. The pellet durability index (PDI) may be determined using a procedure described in U.S. Patent Application No. 20030170371, published Sep. 11, 2003 which was adapted from McEllhiney, R. R. ((technical Editor). 1985. Appendix G Wafers, Pellets, and Crumbles--Definitions and methods for determining specific weight, durability, and moisture content; Section 6 Durability; Paragraph 2, Pellets and crumbles. In Feed Manufacturing Technology III. American Feed Industry Association, Arlington Va.), the disclosure of each is herein incorporated by reference. The procedure generally includes the following steps: (1) obtain a composite product sample by obtaining several samples at regular intervals throughout production and mixing the samples together for testing; (2) screen the sample with the appropriate screen as set forth on the Screen Sizes for Pellet and Crumbles Durability Tests (Table 1 of U.S. Patent Application No. 20030170371), by shaking it 30 times; (3) Place a 500-gram sample (±10 grams) in a tumbler compartment and tumble at about 54 rpm for about 10 minutes; (4) screen sample with the appropriate screen as set forth on the Screen Sizes for Pellet and Crumbles Durability Tests by shaking it approximately 30 times; and (5) document the amount of sample and the amount of screened product.

Generally, the pelleting process according to some aspects of the present invention results in a reduction in waste feed, i.e., pelleted feed compositions that do not remain in pelleted form. Waste feed may be measured by the pellet durability index. Preferably, the pelleting process according to some aspects of the present invention results in a pelleted animal feed composition that has a pellet durability index of at least about 80%. Preferably, this pellet durability index is from about 80% to about 95%. Even more preferably, the pellet durability index of some aspects of the present invention is from about 85% to about 95%. Generally, the pelleted animal feed composition according to some aspects of the present invention is at least about 80% soybean meal and corn meal, on a total weight basis. Preferably, the combination of soybean meal and corn meal comprise at least about 85% of the total weight of the pelleted animal feed composition. More preferably, the combination of soybean meal and corn meal comprise at least about 90% of the total weight of the pelleted animal feed composition.

Generally, total available energy in pelleted animal feed may be increased by increasing fat levels. However, fat levels above the 3% to 4% range, when included at the mixer, may significantly impact pellet quality and thus provide an upper limit on total available energy in conventional pelleted animal feed compositions. According to some aspects of the present invention, this upper limit may be exceeded by use of the high nutrient concentration starting materials. Variations of the pelleting process have been attempted to maintain pellet quality and increase total available energy, but all use variations that include additional amounts of fat or include additional manufacturing steps that increase manufacturing time cycles. These manufacturing increases adversely affect the environment in not only increased energy requirements but also increased waste. Additionally, many of these variations are economically unfeasible for production of bulk animal feed compositions for a number of species.

One attempt, post pelleting fat addition includes spraying fat onto the outer surface of the pellets. This step may be performed before or after the cooling process. This process, however, is limited by the amount of fat that may be sprayed on to the pellet, which generally allows additional levels of fat of up to 8% (on top of that added at the mixer). Another attempt, the use of expanders, allows for high mechanical shear and elevated conditioning temperatures, for example, about 250° F. This allows for improved pellet quality, although the cost of installation and operation is high, thus unnecessarily raising the cost of manufacturer to feed and in some instances being cost-prohibitive. Yet another attempt, double pelleting, involves repelleting the hot pellet through a second die. Other variations, such as the use of UPC (Universal Pellet Cooking), Compactors, Pressurized Pelleting, are not commonly used due to the high cost of operation.

Some aspects of the present invention achieve pelleted high nutrient concentration feed compositions using conventional pelleting techniques in conjunction with all or few of the steps discussed above to achieve a formulation that may be economically feasible while proving a high nutrient concentration diet to the animal without sacrificing pellet quality. According to one aspect of the invention a diet formulated to more accurately meet the nutrient needs of the animal, both initially, and throughout the entire animal feeding cycle are provided.

According to some aspects of the present invention, the animal is generally fed a higher weight of pelleted feed composition per kilogram of the animal at the beginning of the diet. This amount of feed per kilogram of animal generally decreases throughout the lifetime of the animal. Specifically for broilers, the amount of feed composition per kilogram broiler is about 0.2 kg feed per kilogram broiler during the initial period of the animal's lifetime and decreases to about 0.1 kg feed per kilogram broiler during the final period of the animal's lifetime. The daily decrease in feed per kilogram broiler is dependent on the actual feed composition being used and the actual weight of the broiler and generally exceeds about 0.001 kilogram per kilogram broiler. According to some aspects of the invention, the initial pelleted broiler feed composition is formed from the materials and by processes described herein so that the initial pelleted broiler feed composition has a total protein level that is generally from about 220 to about 330 g per kilogram initial broiler feed composition and preferably from about 250 to about 300 g per kilogram initial broiler feed composition. Generally, the initial broiler feed composition has at least about 3150 kilocalories of total available energy per kilogram initial broiler feed composition. Further, the initial broiler feed composition generally has a ratio of less than about 13.5 kilocalories per gram total amino acids where the amino acids include at least lysine, methionine, threonine, and tryptophan. Preferably, the ratio is from about 5 to about 13 kilocalories per gram total amino acids. More preferably, the ration is from about 10 to about 13 kilocalories per gram total amino acids. Generally, the initial broiler feed composition also has lysine content ratio of less than about 230 kilocalories per gram lysine. Preferably, the ratio of total available energy per gram lysine is from about 150 to about 225 kilocalories per gram lysine. More preferably, the ration is from about 180 to about 220 kilocalories per gram lysine. Generally, the initial broiler feed composition is provided to broilers for less than about the first half of their lifecycle. Preferably, the initial broiler feed composition is provided to broilers for less than about the first third of their lifecycle. More preferably, the initial broiler feed composition is supplied for less than about the first week of their lifecycle. The initial feed composition generally provides less than about 10% of the total amount of amino acids provided to the broiler during its lifecycle.

According to some other aspects of the present invention, the animal may also generally be fed a lower weight of pelleted feed composition per kilogram of the animal at the end of the diet. This amount of feed per kilogram of animal generally decreases throughout the lifetime of the animal. Specifically for broilers, the amount of feed composition per kilogram broiler is about 0.1 kg feed per kilogram broiler during the final period of the animal's lifetime. The daily decrease in feed per kilogram broiler is dependent on the actual feed composition being used and the actual weight of the broiler and generally exceeds about 0.001 kilogram per kilogram broiler. According to some aspects of the invention, the final pelleted broiler feed composition is formed from the materials and by processes described herein so that the final pelleted broiler feed composition has a total protein level that is generally from about 150 to about 250 g per kilogram final broiler feed composition and preferably from about 180 to about 220 g per kilogram final broiler feed composition. The final broiler feed composition generally has at least about 3350 kilocalories of total available energy per kilogram final broiler feed composition. Preferably, the amount of total available energy per kilogram final broiler feed composition is from about 3350 to about 3600 kilocalories per kilogram final broiler feed composition. Further, the final broiler feed composition generally has a ratio of at least about 17.0 kilocalories per gram total amino acids where the amino acids include at least lysine, methionine, threonine, and tryptophan. Preferably, the ratio is from about 17.5 to about 23 kilocalories per gram total amino acids. More preferably, the ration is from about 18 to about 22 kilocalories per gram total amino acids. Generally, the final broiler feed composition also has lysine content ratio of at least about 320 kilocalories per gram lysine. Preferably, the ratio of total available energy per gram lysine is from about 320 to about 350 kilocalories per gram lysine. More preferably, the ration is from about 320 to about 335 kilocalories per gram lysine. Generally, the final broiler feed composition is provided to broilers for less than about the last half of their lifecycle. Preferably, the final broiler feed composition is provided to broilers for less than about the last third of their lifecycle. More preferably, the final broiler feed composition is supplied for less than about the last week of their lifecycle.

According to some other aspects of the present invention, the animal may also generally be fed pelleted feed composition that differ from the initial and final pelleted feed compositions during the time period between the initial and final periods of their lifecycles. The number of additional pelleted feed compositions is from about 1 to about 4. Preferably, the number of different feed compositions is from about 1 to about 3 and more preferably from about 2 to about 3. Specifically for broilers, the daily amount that these feed compositions are provided to the animal are from about 0.2 to about 0.1 kilograms feed per kilogram animal and daily decreases at least about 0.001 kilogram per kilogram broiler. Generally, the ratio of total protein level to kilogram feed composition, total available energy, ratio of total available energy per gram amino acid and ratio of total available energy to gram lysine in these additional feed compositions are equal to or between the values of these properties from the initial and final broiler feed compositions. Preferably, any one or more of the properties in the additional feed composition varies by a proportional amount from the same property in the initial, final or other additional broiler feed compositions in light of the number of additional feed compositions being provided.

Many livestock producers are compensated for the sale of their animals based upon measurement of specific traits at slaughter. Common procedures involve some measure of carcass muscle content (e.g. liveweight, carcass fat content). Therefore optimizing carcass composition and development time to desired average carcass composition has a substantial impact on the bottom line profit or loss incurred by the producer. Use of high nutrient concentration diets and feeding cycles have been shown to positively impact carcass composition and decrease average carcass development time.

Often feed intake is the factor limiting growth performance of animals in a commercial environment, the first benefit observed when feeding diets or completing animal feeding programs with the pelleted animal feed composition described herein above is that faster growth will be observed. Use of the above described higher nutrient concentration diets in the feeding of livestock results in a reduction in the percentage of daily energy consumption that is going to meet maintenance requirements, both due to greater total quantities of energy consumed per day, and due to a reduction in the total amount of energy required for maintenance during the animals life as fewer days will be required to meet the same target weights compared to currently used diets. Specifically for broilers fed according to some aspects of the present invention recognize a resultant liveweight increase of at least about 2.8 to about 5.0 percent greater than the liveweights of broilers fed currently used diets over the same time period. Further, broilers fed according to some aspects of the present invention recognize a resultant decreased lifecycle time to reach a liveweight of 2.5 kilograms of at least about 2.2 percent.

Reduced waste output is an added benefit of increasing the nutrient concentration and/or the rate or extent of nutrient digestibility of diets being fed. By using less feed or more digestible feed to get equal or greater gain, more nutrients are available to the animal from what is fed, resulting in less solid and/or gaseous waste generation thereby reducing the negative environmental impact from solid waste disposal. Specifically for broilers fed according to some aspects of the present invention recognize a resultant decrease in excreted solid waste of at least about 2.8 percent when measured in grams excreted waste per gram broiler. Additional benefits from the feeding of increased nutrient concentration diets include reduced manufacturing and transportation requirements such as energy, and less waste generation from the manufacturing and/or transportation processes as less feed is needed to obtain the same animal production, along with the reduced manufacturing and or transportation costs for each process. The end result of these benefits is that the livestock producer would observe an increase in his margins over feed costs due to the factors discussed above. Further exemplary embodiments of some aspects of the present invention are provided below with respect to broilers.

### EXAMPLE 1

A 42 day experiment was conducted to evaluate some aspects of the present invention on Ross 308 broiler chicks. Each of the dietary treatments was provided to 11 pens of 14 broilers per pen. On day 7 the number of birds per pen was reduced to 12 broilers. Dietary treatments consisted of provision of pelleted animal feed composition using traditional feeding methods. The feeding programs evaluated were two high nutrient concentration feeding programs according to some aspects of the present invention HNC (A) and HNC (B) and two industry available feeding programs (actual feeding of broilers was not performed for the industry available feeding programs). The first industry available feeding program is the Ross North American feeding program (specifics of which are available at http://www.aviagen.com/docs/308%20Broiler%20Supplement.pdf). The second industry available feeding program is consistent with a feeding program adapted from the 1994 Nutrient Requirements of Poultry (NRC). In the following tables amino acid values are expressed as total amino acids in the diet, not digestible amino acids.

Day 0-7 Pelleted Feed Compositions

| | Ross - | | | |
|---|---|---|---|---|
| | North America | HNC (A) | HNC (B) | NRC |
| Total Available | 3042 | 3240 | 3400 | 3200 |
| Energy (kcal) per | | | | |
| kg feed | | | | |
| composition | | | | |
| Lysine % | 1.35 | 1.74 | 1.83 | 1.10 |
| Lysine g/day | 0.297 | 0.383 | 0.403 | 0.242 |
| Methionine g/day | 0.117 | 0.132 | 0.136 | 0.110 |
| Total Sulfur Amino | 0.213 | 0.227 | 0.235 | 0.198 |
| Acids g/day | | | | |
| Threonine g/day | 0.191 | 0.235 | 0.246 | 0.176 |
| Tryptophan g/day | 0.048 | 0.066 | 0.070 | 0.044 |
| Intake g/day | 22 | 22 | 22 | 22 |

Day 7-14 Pelleted Feed Compositions

| | Ross - | | | |
|---|---|---|---|---|
| | North America | HNC (A) | HNC (B) | NRC |
| Total Available | 3042 | 3325 | 3495 | 3200 |
| Energy (kcal) per | | | | |
| kg feed | | | | |
| composition | | | | |
| Lysine % | 1.35 | 1.52 | 1.66 | 1.10 |
| Lysine g/day | 0.675 | 0.760 | 0.830 | 0.550 |
| Methionine g/day | 0.265 | 0.265 | 0.285 | 0.250 |
| Total Sulfur Amino | 0.485 | 0.465 | 0.490 | 0.450 |
| Acids g/day | | | | |
| Threonine g/day | 0.435 | 0.490 | 0.520 | 0.400 |
| Tryptophan g/day | 0.110 | 0.135 | 0.145 | 0.100 |
| Intake g/day | 50 | 50 | 50 | 50 |

Day 14-21 Pelleted Feed Compositions

| | Ross - | | | |
|---|---|---|---|---|
| | North America | HNC (A) | HNC (B) | NRC |
| Total Available | 3141 | 3325 | 3495 | 3200 |
| Energy (kcal) per | | | | |
| kg feed | | | | |
| composition | | | | |
| Lysine % | 1.18 | 1.52 | 1.66 | 1.10 |
| Lysine g/day | 0.932 | 1.201 | 1.311 | 0.869 |
| Methionine g/day | 0.363 | 0.419 | 0.450 | 0.395 |
| Total Sulfur Amino | 0.672 | 0.735 | 0.774 | 0.711 |
| Acids g/day | | | | |
| Threonine g/day | 0.600 | 0.774 | 0.822 | 0.632 |
| Tryptophan g/day | 0.150 | 0.213 | 0.229 | 0.158 |
| Intake g/day | 79 | 79 | 79 | 79 |

Day 21-28 Pelleted Feed Compositions

| | Ross - | | | |
|---|---|---|---|---|
| | North America | HNC (A) | HNC (B) | NRC |
| Total Available | 3141 | 3414 | 3587 | 3200 |
| Energy (kcal) per | | | | |
| kg feed | | | | |
| composition | | | | |
| Lysine % | 1.18 | 1.23 | 1.34 | 1.00 |
| Lysine g/day | 1.298 | 1.353 | 1.474 | 1.100 |
| Methionine g/day | 0.506 | 0.484 | 0.517 | 0.418 |
| Total Sulfur Amino | 0.935 | 0.869 | 0.913 | 0.792 |
| Acids g/day | | | | |
| Threonine g/day | 0.836 | 0.891 | 0.946 | 0.814 |
| Tryptophan g/day | 0.209 | 0.242 | 0.264 | 0.198 |
| Intake g/day | 110 | 110 | 110 | 110 |

Day 28-35 Pelleted Feed Compositions

| | Ross - | | | |
|---|---|---|---|---|
| | North America | HNC (A) | HNC (B) | NRC |
| Total Available | 3042 | 3414 | 3587 | 3200 |
| Energy (kcal) per | | | | |
| kg feed | | | | |
| composition | | | | |
| Lysine % | 1.09 | 1.23 | 1.34 | 1.10 |
| Lysine g/day | 1.526 | 1.722 | 1.876 | 1.400 |
| Methionine g/day | 0.602 | 0.616 | 0.658 | 0.532 |
| Total Sulfur Amino | 1.120 | 1.106 | 1.162 | 1.008 |
| Acids g/day | | | | |
| Threonine g/day | 1.008 | 1.134 | 1.204 | 1.036 |
| Tryptophan g/day | 0.252 | 0.308 | 0.336 | 0.252 |
| Intake g/day | 140 | 140 | 140 | 140 |

Day 35-42 Pelleted Feed Compositions

| | Ross - | | | |
|---|---|---|---|---|
| | North America | HNC (A) | HNC (B) | NRC |
| Total Available | 3218 | 3450 | 3625 | 3200 |
| Energy (kcal) per | | | | |
| kg feed | | | | |
| composition | | | | |
| Lysine % | 1.03 | 1.07 | 1.09 | 1.00 |
| Lysine g/day | 1.751 | 1.819 | 1.853 | 1.700 |
| Methionine g/day | 0.714 | 0.629 | 0.663 | 0.646 |
| Total Sulfur Amino | 1.343 | 1.173 | 1.224 | 1.224 |
| Acids g/day | | | | |
| Threonine g/day | 1.190 | 1.190 | 1.224 | 1.258 |
| Tryptophan g/day | 0.306 | 0.323 | 0.323 | 0.306 |
| Intake g/day | 170 | 170 | 170 | 170 |

### EXAMPLE 2

Results from multiple trials performed according to the procedure described for Example 1 were performed with insignificant variations in number of birds per pen, repetitions, and input components for broiler feed compositions. Insignificant variations, within the range of manufacturing process controls, from the Ross—North America compositions are listed as “Mod Ross.” The following represents the average weights per broiler for each of the multiple trials.

Carcass Composition

| | Broiler | Carcass | | |
|---|---|---|---|---|
| | Weight, Live | Weight | Fat Pad | Breast Weight |
| | (grams) | (grams) | (grams) | (grams) |
| Mod Ross #1 | 2455.2 | 1716.5 | 40.09 | 466.17 |
| Mod Ross #2 | 2483.8 | 1750.3 | 36.22 | 475.31 |
| Mod Ross #3 | 2509.1 | 1771.5 | 39.09 | 493.21 |
| HNC (A) #1 | 2613.8 | 1849.2 | 33.98 | 509.69 |
| HNC (A) #2 | 2592.8 | 1836.6 | 33.74 | 519.25 |

### EXAMPLE 3

Results from multiple trials performed according to the procedure described for Example 1 were performed with insignificant variations in number of birds per pen, repetitions, and input components for broiler feed compositions. Insignificant variations, within the range of manufacturing process controls, from the Ross-North America compositions are listed as “Mod Ross.” The following represents the average reduction in waste output weights per g broiler for each of the multiple trials.

Waste Excrement Reduction

| | Excrement (grams) | Excrement (grams) |
|---|---|---|
| | per gram | per gram |
| | broiler, day 21 | broiler, day 42 |
| Mod Ross #1 | 0.177 | 0.169 |
| Mod Ross #2 | 0.169 | 0.163 |
| Mod Ross #3 | 0.173 | 0.164 |
| HNC (A) #1 | 0.162 | 0.156 |
| HNC (A) #2 | 0.162 | 0.157 |

### EXAMPLE 4

Results from multiple trials performed according to the procedure described for Example 1 were performed with insignificant variations in number of birds per pen, repetitions, and input components for broiler feed compositions. Insignificant variations, within the range of manufacturing process controls, from the Ross—North America compositions are listed as “Mod Ross.” The following represents the average time to achieve target weight of 2500 grams per broiler for each of the multiple trials. The Days to 2.5 kg calculations are made using actual daily gains observed from day 35 to 42 of the bird experiments used to obtain day 35 data. Data from Mod Ross #1, #2, and #3, as well as HNC (A) #1 and HNC (A) #2 were derived from one experiment, while Mod Ross #4, HNC (A) #3, and HNC (B) #1 were derived from a second experiment

Lifecycle Reduction

| | Weight at 35 days (grams) | Days to 2.5 Kg Weight |
|---|---|---|
| Mod Ross #1 | 1837 | 42.37 |
| Mod Ross #2 | 1853.5 | 41.91 |
| Mod Ross #3 | 1850.2 | 41.92 |
| Mod Ross #4 | 1880.7 | 44.03 |
| HNC (A) #1 | 1968.6 | 40.68 |
| HNC (A) #2 | 1935.6 | 40.83 |
| HNC (A) #3 | 2015.9 | 41.90 |
| HNC (B) #1 | 2067.1 | 41.10 |

### EXAMPLE 5

Results from multiple trials performed according to the procedure described for Example 1 were performed with insignificant variations in number of birds per pen, repetitions, and input components for broiler feed compositions. Insignificant variations, within the range of manufacturing process controls, from the Ross-North America compositions are listed as “Mod Ross.” The following represents the average daily gain (ADG) in grams per day and feed efficiency of birds over a 42 day feeding period. Data from Mod Ross #1, #2, and #3, as well as HNC (A) #1 and HNC (A) #2 were derived from one experiment, while Mod Ross #4, HNC (A) #3, and HNC (B) #1 were derived from a second experiment

Growth Performance

| | ADG (g/d) | Body Weight (g) on day 42 | Feed Efficiency |
|---|---|---|---|
| Mod Ross #1 | 57.85 | 2467 | 0.624 |
| Mod Ross #2 | 58.83 | 2508 | 0.644 |
| Mod Ross #3 | 58.78 | 2507 | 0.635 |
| Mod Ross #4 | 56.57 | 2414 | 0.595 |
| HNC (A) #1 | 61.58 | 2624 | 0.675 |
| HNC (A) #2 | 61.35 | 2614 | 0.665 |
| HNC (A) #3 | 60.58 | 2584 | 0.581 |
| HNC (B) #1 | 61.23 | 2610 | 0.607 |

The present invention has been described herein with reference to specific illustrative embodiments thereof. It will be apparent to those skilled in the art that a person understanding this invention may conceive of changes or other embodiments or variations, which utilize the principles of this invention without departing from the broader spirit and scope of the invention as set forth in the appended claims. All are considered within the sphere, spirit, and scope of the invention.

1. A pelleted feed composition providing about 3150 kilocalories to about 3600 kilocalories of available energy per kilogram of composition and a total amount of amino acids, the composition comprising a ratio of total available energy to total amount of amino acids is less than about 13.5 kilocalories or greater than about 17.0 kilocalories per gram with an average pellet durability index of at least about 85%.

2. The feed composition of claim 1 wherein the average pellet durability index of the pellet feed composition is at least about 90%.

3. The feed composition of claim 1 wherein the feed composition comprises a mixture of components wherein one of the components is a corn meal having on a dry weight basis a starch content from about 65% to about 85% and a protein content from about 7.5% to about 24.0%.

4. The feed composition of claim 3 wherein the corn meal comprises on a dry weight basis a starch content of about 65%, and a protein content of at least about 14%.

5. The feed composition of claim 3 wherein a second component comprises a soy meal having a protein content of at least about 58% protein on a dry weight basis.

6. The composition of claim 3 wherein said corn meal comprises ground transgenic corn with an increased lysine concentration.

7. The composition of claim 6 wherein the transgenic corn comprises LY038.

8. The feed composition of claim 6 wherein the ratio of total available energy to grams lysine is less than about 230 kilocalories per gram.

9. An animal feed pellet comprising at least about 200 grams of total protein per kilogram of pellets and a ratio of kilocalories of total available energy to grams total amino acids is less than about 13.5 or greater than about 17.0 kilocalories per gram.

10. The animal feed pellet of claim 9 wherein the average pellet durability index is at least about 85%.

11. The animal feed pellet of claim 9 wherein the pellet provides from about 3150 to about 3600 kilocalories of available energy per kilogram

12. The animal feed pellet of claim 9 further comprising a ratio of total available energy to grams lysine less than about 230 kilocalories per gram.

13. The animal feed pellet of claim 9 wherein said pellet further comprises a mixture of a soy meal and a corn meal wherein said soy meal and corn meal are at least 80% by weight of the animal feed pellet.

14. The animal feed pellet of claim 9 wherein said soy meal has a dry weight basis protein content of at least 58%.

15. The animal feed pellet of claim 9 wherein said corn meal has a dry weight basis starch content from about 65 to about 85 percent and a dry weight basis protein content from about 7.5 to about 24 percent.

16. The composition of claim 15 wherein said corn meal comprises ground transgenic corn with an increased lysine concentration.

17. The composition of claim 16 wherein the transgenic corn comprises LY038.

18. A pelleted animal feed composition having a ratio of less than about 13.5 or greater than about 17.0 kilocalorie total available energy per gram total amino acids and providing at least 3150 kilocalories of total available energy per kilogram of composition comprising a mixture of a first component having a dry weight basis starch content from at least about 65% to about 85% and a dry weight basis protein content of from about 7.5% to about 24% by and a second component having a dry weight basis protein content of at least about 58% protein.

19. The animal feed composition of claim 18 wherein the average pellet durability is at least about 85%.

20. The animal feed composition of claim 18 wherein said starch content of said first component is less than about 80%.

21. The animal feed composition of claim 18 wherein the ratio of total available energy to grams lysine is less than about 230 kcal per gram.

22-100. (canceled)
